(19) United States
(12) Patent Application Publication
(10) Pub. No.: US 2013/0018134 A1
(43) Pub. Date: Jan. 17, 2013

(54) POLYCHLOROPRENE COMPOSITIONS WITH IMPROVED ADHESION PROPERTIES

(71) Applicant: LANCE ALAN CHRISTELL, LEBANON, TN (US)

(72) Inventor: LANCE ALAN CHRISTELL, LEBANON, TN (US)

(73) Assignee: E I DU PONT DE NEMOURS AND COMPANY, Wilmington, DE (US)

(21) Appl. No.: 13/545,392

(22) Filed: Jul. 10, 2012

Related U.S. Application Data
(60) Provisional application No. 61/506,414, filed on Jul. 11, 2011.

(51) Int. Cl. C09J 111/00; B29C 39/38; C08K 5/13; C08K 3/22; C08L 11/00; C08K 5/01

(52) U.S. Cl. 524/271; 525/215; 264/28

(57) ABSTRACT

Polymer blend compositions are disclosed comprising a polychloroprene homopolymer and a polymethacrylic acid having a weight average molecular weight of not greater than 50,000 daltons. A process for preparation of the polymer blend composition is also disclosed. The polymer blend compositions are useful for preparing solvent-based adhesive compositions having excellent high temperature adhesion properties.

### CROSS REFERENCE TO RELATED APPLICATION

This application claims priority from U.S. Patent Application Ser. No. 61/506,414, filed on Jul. 11, 2011, which is incorporated herein by reference in its entirety.

### FIELD OF THE INVENTION

The present invention is directed to a process for production of a polychloroprene polymethacrylic acid polymer blend composition that adheres to a variety of substrates and exhibits excellent high temperature adhesive properties.

### BACKGROUND OF THE INVENTION

Polychloroprene elastomers (i.e. cured polymers of 2-chloro-1,3-butadiene (chloroprene)) are well-known materials useful in a wide variety of products, including adhesive compositions and molded goods. Improved adhesion to substrates and high temperature resistance are desirable properties in both applications. For example, with respect to adhesives, high temperature resistance permits usage in a broadened range of household and industrial applications. Strong adhesion is a desirable property in molding applications, especially in instances wherein a rubber composition is molded to a metal insert, such as in engine compartments where metal parts are subjected to high temperatures.

Polychloroprene solvent-based adhesives are commercially available products that are capable of bonding to many types of substrates. Adhesive bond strengths are high and chemical resistance is excellent. However, despite their superior bonding properties, the use of solvent-based adhesives has declined due to environmental and health concerns related to the presence of substantial quantities of volatile organic solvents in such adhesive formulations. As a consequence, the adhesives industry has endeavored to develop alternative polychloroprene compositions that exhibit physical properties equivalent to those of the solvent-based adhesives but which contain lower solvent levels. Among these are numerous commercially available aqueous-based polychloroprene adhesives, such as Weldwood® Contact Adhesive from DAP® or Helmibond from Helmitin®. Some of these compositions contain polychloroprene homopolymers (i.e. polymers having only copolymerized units of 2-chloro-butadiene-1,3) while others contain polychloroprene copolymers (i.e. polymers having copolymerized units of 2-chloro-butadiene-1,3 and at least one additional type of comonomer). Such compositions are described, for example, in U.S. Pat. No. 3,728,316; U.S. Pat. No. 3,920,600; U.S. Pat. No. 5,332,771; and U.S. Pat. No. RE 36,618. In addition, aqueous adhesives that contain blends of chloroprene polymers are known, for example, as disclosed in U.S. Pat. No. 5,407,993. Still, in many instances, aqueous adhesives cannot match the properties of solvent-based adhesives.

Polychloroprene homopolymers are suitable for use in the manufacture of solvent-based adhesives, but the homopolymers often exhibit a loss of strength with increasing temperature. This is not easily remedied. For example, the use of low temperature polymerization conditions to manufacture adhesive grade polychloroprenes has been disclosed in Maynard, J. T. and Mochel, W. E. J, Polymer Science, 18, 227 (1955). Such processes result in production of polymers that exhibit good room temperature adhesion, but high temperature bond strength is not adequately improved. The reason for this phenomenon is that the strength of chloroprene polymers prepared at low temperature is derived from the presence of crystalline regions in the polymer matrix. As is well known in the art, low temperature polymerization enhances the level of crystallinity and raises the room temperature tensile strength of the polymer. However, the crystalline regions melt at higher temperatures, and thus provide no high temperature strength. In addition, as a practical matter, low temperature polymerization is generally undesirable due to the increased reaction time that is an inherent result of conducting chemical reactions at lower temperatures.

The use of the alternative chloroprene copolymer solvent-based adhesives can also present challenges. For example, compositions based on copolymers of chloroprene and methacrylic acid, such as those described in U.S. Pat. No. 3,912,676, can be useful alternatives to chloroprene homopolymer adhesives in many situations. These compositions provide good high temperature adhesion and excellent bond strengths. However, a disadvantage of these compositions is that preparation is expensive. The manufacturing process involves emulsion polymerization under acidic conditions followed by a stripping step to remove unreacted monomer wherein the pH of the polymer latex is increased to 10.5 or more. The resultant latex is then acidified to a pH of 5.5 prior to isolation of the copolymer.

Physical blends of various polymers, including polychloroprene, with salts of high molecular weight polymethacrylic acids in aqueous suspension are known from Japanese Published Patent Application 60-235874. Such compositions can be used as carpet adhesives but these blends are not suitable for production of the polychloroprenes used in solvent-based adhesives. This is because such solvent-based adhesives are produced by dissolution of solid polymer in an organic solvent. Production of solid grades of polychloroprene on a commercial scale is generally conducted by polymerization to form a polychloroprene latex that is then coagulated to form a solid polymer film or sheet on a freeze roll. The addition of the particular class of polyacid salts described in Japanese Published Patent Application 60-235874 to uncoagulated polychloroprene latex creates difficulties in polymer isolation because a self-supporting film cannot be formed from the polychloroprene latex/polyacid salt blend on a freeze roll. Thus, the compositions disclosed in Japanese Published Patent Application 60-235874 are not suitable for commercial scale preparation of polychloroprene compositions or the solvent-based adhesives containing them.

It is also known to blend polychloroprenes having medium levels of gel and crystallinity with certain types of carboxylated acrylic resins to prepare aqueous adhesive compositions, for example, as disclosed in U.S. Patent Publication 2008/0128083. In addition, aqueous contact adhesives are disclosed that contain polychloroprene and a thickening agent that may be an ethylene/carboxylated acrylate polymer, as disclosed in U.S. Pat. No. 6,440,259. These polychloroprene blend compositions would also not be capable of forming a self-supporting film or sheet on a freeze roll.

It would be desirable to have available a cost effective process for production of a polychloroprene composition that could be used as the polymeric component of a solvent-based adhesive formulation that exhibits the excellent high temperature adhesion properties of chloroprene methacrylic acid copolymer solvent adhesives and which utilizes components suitable for the more easily controlled, and less costly process of anionic polymerization or copolymerization and freeze roll isolation.

### SUMMARY OF THE INVENTION

The present invention is directed to polychloroprene polymer compositions useful in preparing adhesives that have excellent adhesive properties and a process for their production.

In one embodiment the invention is directed to a polymer blend composition comprising a 2-chloro-1,3-butadiene homopolymer and polymethacrylic acid, wherein the polymethacrylic acid has a weight average molecular weight of not greater than about 50,000 daltons.

In another embodiment, the invention is directed to a process for isolating a self-supporting film or sheet of a polymer blend composition comprising a 2-chloro-1,3-butadiene homopolymer and a polymethacrylic acid polymer, the process comprising the steps of
A. providing a first aqueous dispersion of a 2-chloro-1,3-butadiene homopolymer;
B. forming an aqueous mixture by blending said first aqueous dispersion with an aqueous composition comprising a polymer selected from the group consisting of polymethacrylic acids, polymethacrylic acid salts, and mixtures thereof, wherein the weight average molecular weight of said polymethacrylic acid and said polymethacrylic acid salt is not greater than about 50,000 daltons and wherein the addition of said aqueous composition takes place under conditions such that the aqueous mixture that is formed has a pH greater than 7.0;
C. acidifying said aqueous mixture to form a second aqueous dispersion;
D. introducing said second aqueous dispersion to the surface of a rotating freeze roll, thereby coagulating said second aqueous dispersion to form a self-supporting film or sheet, wherein said film or sheet comprises a polymer blend composition comprising a mixture of 2-chloro-1,3-butadiene homopolymer and polymethacrylic acid, wherein the polymethacrylic acid is present in said polymer blend composition in an amount of no more than about 2.5 wt. %, based on the total weight of 2-chloro-1,3-butadiene homopolymer and polymethacrylic acid present in said polymer blend composition; and
E. removing the self-supporting film or sheet from the freeze roll.

The invention is also directed to a polychloroprene adhesive composition comprising
A. a 2-chloro-1,3-butadiene homopolymer;
B. a polymethacrylic acid, wherein the polymethacrylic acid has a weight average molecular weight of not greater than about 50,000 daltons;
C. a rosin tackifier;
D. a metal oxide; and
E. an organic solvent.

The invention is further directed to a process for preparing a polychloroprene adhesive composition comprising the steps of
A. providing a polymer blend composition prepared by a process comprising the steps of
1. providing a first aqueous dispersion of a 2-chloro-1,3-butadiene homopolymer;
2. forming an aqueous mixture by blending said first aqueous dispersion with an aqueous composition comprising a polymer selected from the group consisting of polymethacrylic acids, polymethacrylic acid salts, and mixtures thereof, wherein the weight average molecular weight of said polymethacrylic acid and said polymethacrylic acid salt is not greater than about 50,000 daltons and wherein the addition of said aqueous composition takes place under conditions such that the aqueous mixture that is formed has a pH greater than 7.0;
   3. acidifying said aqueous mixture to form a second aqueous dispersion; and
   4. isolating a polymer blend composition from said second aqueous dispersion, the polymer blend composition comprising said 2-chloro-1,3-butadiene homopolymer and polymethacrylic acid, wherein the polymer blend composition comprises no more than about 2.5 wt. % polymethacrylic acid, based on the total weight of 2-chloro-1,3-butadiene homopolymer and polymethacrylic acid present in the polymer blend composition; and
B. forming a polychloroprene adhesive composition comprising said polymer blend composition, a tackifying resin and a metal oxide by mixing the polymer blend composition, rosin tackifier and metal oxide with an organic solvent.

### DETAILED DESCRIPTION OF THE INVENTION

In one embodiment, the present invention is directed to a novel composition comprising a chloroprene homopolymer and a polymethacrylic acid wherein the polymethacrylic acid has a weight average molecular weight of not greater than about 50,000 daltons.

The blend of chloroprene homopolymer and methacrylic acid is advantageously prepared using an aqueous blending technique, although the blend may also be prepared by mixing the individual components by any technique, such as mixing in a Brabender mixer or other mechanical mixer. The blend compositions may also be prepared by mixing solutions and/or emulsions of the chloroprene homopolymer and polymethacrylic acid.

The polychloroprene homopolymers that are components of the polymer blend of the invention may be, for example, mercaptan-modified, iodine-modified, dialkylxanthogen disulfide-modified, or dialkoxyxanthogen disulfide modified chloroprene homopolymers, for example, as disclosed in U.S. Pat. Nos. 2,481,044; 3,042,652; 3,147,317; 3,686,156; and 3,849,372. Preferably, the homopolymers will be mercaptan-modified or xanthogen disulfide-modified because these are the most economical to produce and the mercaptan and xanthogen disulfide modifiers have a reaction rate during the polymerization that matches well with the polymerization rate of chloroprene. Such polymers are commercially available under the tradename Neoprene from DuPont. Most preferably, the chloroprene homopolymers will be mercaptan-modified. The polymethacrylic acid that is suitable for use in the composition of the invention is a polymethacrylic acid having a weight average molecular weight of not more than about 50,000. It is important that the weight average molecular weight is no greater than 50,000 because polymethacrylic acid polymer of such molecular weight is compatible with polychloroprenes. Generally, the molecular weight will be from 4,000 to 30,000 daltons, preferably from 5,000 to 20,000 daltons, most preferably from 6,500 to 10,000 daltons. Polymethacrylic acid is available commercially either in the acid form or in the form of polymethacrylic acid salts. Compositions of the appropriate molecular weight range include Tamol® 960 dispersant, which is a sodium salt of polymethacrylic acid (i.e. sodium polymethacrylate) having a molecular weight of approximately 5,000 daltons, available from The Dow Chemical Co. A suitable method for determination of the weight average molecular weight of polymethacrylic acid is aqueous gel permeation chromatography.

The polymer blend of the invention is advantageously made by a process that comprises the following general steps. An aqueous dispersion of a 2-chloro-1,3-butadiene homopolymer is blended with an aqueous composition comprising either a polymethacrylic acid or a salt of a polymethacrylic acid, the polymethacrylic acid or salt having a weight average molecular weight of not more than about 50,000, thereby forming an aqueous dispersion. The aqueous composition may be an aqueous solution or an aqueous suspension or dispersion. Any monovalent salt of polymethacrylic acid may be used, for example, sodium salts or potassium salts, which are preferred, so long as the salt is dispersible in water and is compatible with the polychloroprene dispersion. The conditions of blending are preferably such that the pH of the dispersion is basic, i.e. greater than 7.0, preferably greater than 10. The resultant mixture is then acidified, generally to a pH of 5.6 to 6, to form a second aqueous dispersion.

The polychloroprene homopolymer dispersion that is mixed with the polymethacrylic acid or salt may be an aqueous dispersion formed during a polychloroprene polymerization reaction. Aqueous dispersions of polychloroprene homopolymers are produced by free radical emulsion polymerization, for example, as disclosed in U.S. Pat. No. 2,567,117.

If the chloroprene homopolymer dispersion component is obtained directly from a polymerization reaction it may comprise various other materials, such as additives, by-products and stabilizing agents normally found in aqueous dispersions that are produced in chloroprene polymerization reactions. Such additives may include unreacted comonomers, rosin or resin salts, polymerization stabilizers such as phenothiazine and/or tert-butyl catechol, surfactants such as Lomar® PW, and by-products such as inorganic sulfate salts.

The polymethacrylic acid or polymethacrylic acid salt dispersion or solution may also comprise additional components that will consequently be present in the acidified aqueous dispersion that is formed as described above. Such additional components may include residual monomer and polymerization by-products.

The blend of chloroprene homopolymer and polymethacrylic acid that is formed after acidification and is present in the second aqueous dispersion described above may be isolated by coagulation of the polymers. On an industrial scale coagulation of chloroprene polymer dispersions is most effectively accomplished using a freeze roll. The blend of the invention is capable of being isolated from the second aqueous dispersion by coagulation on a freeze roll, which is a cost effective method of isolation for polychloroprene rubbers.

In a freeze roll coagulation process, a drum, generally chilled to a temperature at or below −12° C., rotates through a container of aqueous chloroprene dispersion resulting in formation of a frozen film or sheet on the drum surface. Typically, the film or sheet will be removed from the freeze roll using a doctor knife. For effective operation the film or sheet should be self-supporting, by which is meant that it supports its own weight without tearing while being pulled from the doctor knife and maintains its integrity while being water-washed. Thus, in one embodiment of the invention a process is provided whereby a self-supporting film or sheet of a polymer blend comprising a chloroprene polymer and polymethacrylic acid is formed.

The blend of chloroprene homopolymer and polymethacrylic acid of the invention will generally contain no more than 2.5 wt. % polymethacrylic acid based on the total weight of chloroprene homopolymer and polymethacrylic acid. Preferably the blend will comprise 0.3-2.0 wt. % polymethacrylic acid, based on the total weight of chloroprene homopolymer and polymethacrylic acid. More preferably the blend will comprise 0.6-1.5 wt. % polymethacrylic acid, based on the total weight of chloroprene homopolymer and polymethacrylic acid. Such mixtures are capable of forming self-supporting films or sheets when cooled to −15 ° C. on a freeze roll as described in U.S. Pat. No. 2,187,146 to Calcott et al. The film or sheet can be collected and removed from the freeze roll surface in any manner, usually by being scraped from the surface with a doctor blade and pulled onto a wash belt, forming a film or sheet which is conveyed to a dryer, the film or sheet being subsequently formed into a rope which is later cut into chips and packaged.

Prior art processes that disclose preparation of blends of chloroprene polymers and polymethacrylic acid involve the use of high molecular weight polymethacrylic acids and their salts, rather than polymethacrylic acids of the molecular weight useful in the practice of the present invention. Such compositions do not form self-supporting films or sheets under freeze roll isolation conditions and are difficult to isolate. The present process provides compositions that are easily recoverable and may be used to form rubber articles, such as belts, hoses and gaskets, as well as adhesive compositions.

The self-supporting polymer blend film or sheet prepared as described above will generally be heated and dried, preferably in a serpentine dryer at a temperature of between 90° C.-120° C. to form a material that can be packaged and is suitable for use as an elastomer, generally as an elastomer for use in adhesive formulations. For example, the dried polymer blend film or sheet may be converted into solid polymer chips by gathering the film or sheet into a rope and cutting the rope into small pieces or chips, generally in size of about 1×2×⅛ inches. These chips are usually coated with an anti-massing agent, such as talc.

Although the polymer blend of the invention is most effectively isolated by use of a freeze roll, isolation may also be accomplished using means such as steam-heated drum dryers or other isolation techniques known to those of skill in the art.

The above-described method for preparing a blend of a polychloroprene homopolymer and a low molecular weight polymethacrylic acid provides a polymer blend that, when formulated into a solvent-based adhesive, is suitable for use at temperatures in excess of 100° C. Thus, in one embodiment, the invention is directed to a method for producing polychloroprene/polymethacrylic acid polymer blend compositions that are suitable for use in preparing solvent-based adhesives having enhanced high temperature resistance.

In another embodiment, the invention is directed to adhesives comprising the polychloroprene/polymethacrylic acid blend of the invention and in a further embodiment, the invention is directed to a process to produce adhesives comprising polychloroprene homopolymers that have excellent high temperature resistance and also exhibit high bond strength.

The adhesive compositions of the invention comprise a 2-chloro-1,3-butadiene homopolymer (i.e. a polychloroprene homopolymer) and polymethacrylic acid, wherein the polymethacrylic acid has a weight average molecular weight of not greater than about 50,000 daltons. The adhesive compositions additionally comprise a rosin tackifier, metal oxide, and an organic solvent.

The rosin tackifier is present in an amount of from about 1 to about 75 parts per 100 parts of the chloroprene homopolymer. The rosins suitable for use include, for example, acids or terpenoid esters such as esters of abietic acid, hydrogenated abietic acid, disproportionated abietic acid, or polymerized abietic acid. Normally, the esters are lower alkyl esters of two to six carbon atoms, but this is not a critical limitation. Also, mixtures of rosins are contemplated. Rosins modify adhesive characteristics, e.g. tack, adhesion, cohesion and hot bond strength. Adhesives of the present invention containing rosin concentrations of 1 to 75 parts per 100 parts chloroprene homopolymer exhibit rapid bond strength development and high temperature resistance. Poor adhesion to some surfaces results if levels of less than 1 part rosin are used. In contrast, if greater than 75 parts are used, the heat resistance of the compositions is decreased. Preferably 10-60 parts rosin are used per 100 parts of chloroprene homopolymer. Most preferably 20-40 parts per 100 parts of chloroprene homopolymer as used because this provides the best balance of properties.

The metal oxide component of the adhesive compositions, for example magnesium oxide or zinc oxide, acts as both acid acceptor and curing co-agent and reduces acid tendering of the adhesives. The metal oxides contribute to curing by reaction with either the polychloroprene and/or the resin components, particularly if the resins are t-butyl phenolic resins. Generally the metal oxides, which act as crosslinking agents, are present at a level of about 2 to about 10 parts of either metal oxide per one hundred parts of chloroprene homopolymer (parts per hundred parts rubber, i.e. phr) in the adhesive. The metal oxides can be added singly or in combination. They are preferably used in combination at a concentration of 4 to 8 phr of each component. Zinc and magnesium oxide are preferred metal oxides, but other metal oxides, such as the oxides of calcium, tin or lead are also suitable for use.

The organic solvent or solvents that are additional components of the adhesive compositions of the invention may be selected from those solvents in which chloroprene homopolymers and polymethacrylic acid are soluble. Typical organic solvents suitable for use include toluene, xylene, hexane, mineral spirits, acetone, methyl ethyl ketone, ethyl acetate, n-propylbromide, and methylene chloride. Other suitable solvents will be known to those skilled in the art. Preferred solvents include toluene and xylene or blends of hexane/acetone/toluene which are used in amounts to achieve a desired viscosity and solids content. The viscosity of the final adhesive may be adjusted over a wide range, i.e., for brush grades or spray grades, or for low VOC content, by adjusting the solids content as well as the blend of solvents used.

The process of the invention directed to preparation of an adhesive involves the following general steps. The polymer blend composition, generally in the form of pellets or chips, including any associated additives, by-products and anti-massing agents, is dissolved in an organic solvent. The organic solvent may contain rosin tackifier and metal oxide at the time the polymer blend composition is added or these components may be added subsequently. Additional additives and compounding agents commonly used in solvent-based chloroprene adhesive compositions may be added to optimize certain physical properties. Such additives include antioxidants, antiozonants, such as Wingstay® L, Santowhite® crystals and Antozite®, tackifying resins, such as 1-t-butylphenolic or maleic anhydride-modified rosin esters, and resins, such as hydrocarbon resins, e.g. SP-154, available from SI Group. The additives may be present in the organic solvent when it is combined with the chloroprene polymer or the additional components may be added after the chloroprene polymer is dissolved. This will depend upon the particular additives and chloroprene polymer type and will be known to those skilled in the art of preparing adhesive formulations.

The adhesives of the invention have outstanding high temperature properties. That is, they are generally characterized by exhibiting tensile shear strengths above 250 newtons at temperatures in excess of 120° C. when tested according to the following procedure: the rough surface of a sheet of Wilsonart® high pressure laminate having dimensions of 1 inch by 4 inches and the surface of a 1 inch by ¾ inch by 4 inch piece of high density particle board are each coated on one end with a sample of a solvent-borne adhesive composition containing 100 parts polychloroprene/polymethacrylic acid sheet prepared by the process of the invention, 49 parts SP 154 heat reactive phenolic resin tackifier, available from SI Group, 4 parts zinc oxide, 8 parts magnesium oxide, 2 parts Wingstay® L, (a butylated reaction product of p-cresol and dicyclopentadiene, available from Eliokem) and 652 parts toluene. The solvent-borne adhesive is applied at a deposition level of 1g/square inch. The coated sheets are overlapped in a two inch area and pressure is applied by rolling. Specifically, three bonded pieces are subjected to a process of one cycle of being rolled back and forth longitudinally, under a 4 inch diameter roller loaded with 180 lbs. of weight (contact pressure of approximately 60 pounds per linear inch) to bond the surfaces. The test specimens are held at room temperature for 24 hours and tested for tensile shear strength by applying 100% shear stress on the specimen while it is held rigid in a test jig to prevent bending of the specimen.

Use of adhesives that have tensile shear strengths of above 250 newtons at temperatures in excess of 120° C. permits adequate adhesion between surfaces during manufacture of bonded articles at temperatures above 100° C. and results in excellent adhesion in articles that are subjected to temperatures above 120° C. in use. Examples of such articles include headliners of automobiles or trailers and laminated kitchen surfaces suitable for use near a stovetop. The high temperature strength exhibited by adhesives of the invention is significantly greater than that of adhesives containing the same formulation additives but wherein the polymer component is solely a polychloroprene homopolymer rather than a blend of polychloroprene homopolymer and polymethacrylic acid of molecular weight less than 50,000 daltons.

The process for preparation of the polychloroprene homopolymer/polymethacrylic acid blend described herein is particularly adapted to manufacture of organic solvent-based chloroprene homopolymer adhesives having good high temperature adhesion properties. For example, a chloroprene homopolymer adhesive that is formulated from a blend of the polychloroprene homopolymer and polymethacrylic acid when used to bond a high pressure melamine or acrylic plastic laminate such as Formica® laminates and Wilsonart® laminates to cabinet grade wood or particle board can improve the high temperature strength of the laminate by a factor of three or more. This is especially valuable in locations where the laminate is installed near a heat source, for example near an oven or dishwasher in the home, or in the interior compartment of a vehicle that may be parked in the sun.

The invention is further illustrated by the following examples of certain embodiments.

### EXAMPLES

### Example 1

A dodecylmercaptan modified chloroprene homopolymer was prepared as follows. A chloroprene monomer dispersion was prepared at ambient temperature by feeding a mixture of 100 parts chloroprene, 3 parts rosin and 0.12 parts dodecylmercaptan to a glass/glass-lined polymerization reactor containing an aqueous solution of 84 parts water, 0.46 parts sodium hydroxide, 0.4 parts sodium naphthalene sulfonate, and 0.15 parts sodium sulfite. The temperature of the reaction mixture was increased to 45° C. and polymerization was initiated by introduction of a dilute aqueous solution of potassium persulfate and sodium anthraquinone sulfonate. The polymerization was short-stopped by addition of aqueous solutions of phenothiazine and t-butyl catechol when the conversion reached a level of 68%.

A sample of the resultant short-stopped polymer dispersion was blended with an aqueous solution of low molecular weight sodium polymethacrylate (molecular weight 6500 daltons). The amount of sodium polymethacrylate added was 1.35 parts of sodium polymethacrylate (as 29.7% aqueous solution) per 100 parts chloroprene monomer that had been charged to the reactor during polymerization. Unreacted monomer was then removed and the resultant dispersion was acidified with acetic acid to a pH of 5.5, thereby forming a chloroprene homopolymer/polymethacrylic acid dispersion. A solid polymer blend composition was isolated from the acidified dispersion by contacting it with a freeze roll to form a solid polymer sheet that was subsequently dried. The dried polymer composition contained 98.65 wt % chloroprene homopolymer and 1.35 wt % polymethacrylic acid based on the total weight of chloroprene homopolymer plus polymethacrylic acid and had a Mooney viscosity of 106.8, ML 1+4 at 100° C., as determined according to ASTM D1646.

An adhesive composition was prepared as follows. A sample of the dried polymer sheet composition was compounded on a rubber mill with the solid ingredients listed in Table I. The resultant blend and 652 parts of toluene were combined and the mixture was agitated using a roll mixer until it was homogeneous thereby forming a solvent-borne adhesive. Bonded test specimens for use in testing tensile shear strength were prepared as follows.

The rough surface of a sheet of Wilsonart® high pressure laminate having dimensions of 1 inch by 4 inches, and the surface of a 1 inch by ¾ inch by 4 inch piece of high density particle board were each coated on one end with a sample of the solvent-borne adhesive at a deposition rate of 1g/square inch. The coated sheets were overlapped in a two inch area and pressure was applied by rolling three bonded test specimens back and forth, one cycle, longitudinally, with a 4 inch diameter roller loaded with 180 lbs. of weight (contact pressure of approximately 60 pounds per linear inch) to bond the surfaces of the specimens. The test specimens were held at room temperature for 24 hours and tested for tensile shear strength by applying 100% shear stress on the specimen while it was held rigid in a test jig to prevent bending of the specimen. Results are shown in Table I.

### Comparative Example A

A sample of the chloroprene homopolymer dispersion of Example 1 that did not contain polymethacrylic acid salt was acidified with acetic acid to a pH of 5.5. A solid polymer composition was isolated from the acidified dispersion by contacting it with a freeze roll to form a solid polymer sheet that was subsequently dried. The resultant polymer composition had a Mooney viscosity of 120, ML 1+4 at 100° C., as determined according to ASTM D1646. Adhesive formulations and test specimens were prepared as described in Example 1. Results are shown in Table I.

### Example 2

A sample of the chloroprene homopolymer dispersion of Example 1 was blended with an aqueous solution of a low molecular weight salt of polymethacrylic acid, i.e. sodium polymethacrylate having a molecular weight 9500 daltons. The amount of sodium polymethacrylate added was 1.35 parts solid sodium polymethacrylate (as a 30% aqueous solution) per 100 parts chloroprene monomer charged to the reactor during polymerization. The resultant dispersion was acidified to a pH of 5.5 by addition of acetic acid. A solid polymer composition was isolated from the acidified dispersion by contacting the dispersion with a freeze roll to form a solid polymer sheet that was subsequently dried. The dried polymer composition contained 98.65 wt % chloroprene homopolymer and 1.35 wt % polymethacrylic acid based on the weight of the chloroprene homopolymer plus polymethacrylic acid and had a Mooney viscosity of 106.4, ML 1+4 at 100° C., as determined according to ASTM D1646. Adhesive formulations and test specimens were prepared as described in Example 1. Results are shown in Table 1.

### Example 3

A chloroprene homopolymer dispersion was prepared as described in Example 1, except that 0.22 parts per hundred parts chloroprene of dodecylmercaptan was used. The dispersion was steam stripped to remove unreacted monomer. The stripped dispersion was blended with an aqueous solution of a low molecular weight sodium polymethacrylate having a molecular weight of 6500 daltons. The amount of sodium polymethacrylate added was 0.75 parts solid sodium polymethacrylate (as a 29.7% aqueous solution) per 100 parts chloroprene monomer charged to the reactor during polymerization. The resultant dispersion was acidified to a pH of 5.5 with acetic acid. A solid polymer composition was isolated from the acidified dispersion by contacting the dispersion with a freeze roll to form a solid polymer sheet that was subsequently dried. The polymer composition contained 99.24 wt % chloroprene homopolymer and 0.76 wt % polymethacrylic acid based on the weight of chloroprene homopolymer plus polymethacrylic acid and had a Mooney viscosity of 124.9, ML 1+4 at 100° C., as determined according to ASTM D1646. Adhesive formulations and test specimens were prepared as described in Example 1. Results are shown in Table I.

### Example 4

A sample of the chloroprene homopolymer dispersion of Example 1 was blended with an aqueous solution of a low molecular weight salt of polymethacrylic acid, i.e. sodium polymethacrylate having a molecular weight of 30,000 daltons. The amount of sodium polymethacrylate added was 1.35 parts solid sodium polymethacrylate (as a 30% aqueous solution) per 100 parts chloroprene monomer charged to the reactor during polymerization. The resultant dispersion was acidified to a pH of 5.5 by addition of acetic acid. A solid polymer composition was isolated from the acidified dispersion by contacting the dispersion with a freeze roll to form a solid polymer sheet that was subsequently dried. The polymer composition contained 98.65 wt % chloroprene homopolymer and 1.35 wt % polymethacrylic acid based on the weight of chloroprene homopolymer plus polymethacrylic acid. Adhesive formulations and test specimens were prepared as described in Example 1. Results are shown in Table I.

TABLE I

| | Ex. 1 | Comp. A | Ex. 2 | Ex. 3 | Ex. 4 |
|---|---|---|---|---|---|
| Polymer | 100 | 100 | 100 | 100 | 100 |
| SP 154¹ | 49 | 49 | 49 | 49 | 49 |
| Zinc Oxide | 4 | 4 | 4 | 4 | 4 |
| Magnesium | 8 | 8 | 8 | 8 | 8 |
| Oxide² | | | | | |
| Wingstay ® L³ | 2 | 2 | 2 | 2 | 2 |
| Toluene | 652 | 652 | 652 | 652 | 652 |
| Shear | | | | | |
| Room Temp., | 2259 | 2609 | — | 1600 | 2202 |
| (newtons) | | | | | 2312 |
| | | | | | 2233 |
| 120° C., | 373 | 97 | 336.5 | 267 | 365 |
| (newtons) | | | | | 264 |
| | | | | | 289 |

¹heat reactive phenolic resin tackifier, available from SI Group
²Maglite ® D magnesium oxide, available from The HallStar Co.
³butylated reaction product of p-cresol and dicyclopentadiene, available from Eliokem.

### Comparative Example C

A sample of the chloroprene homopolymer dispersion of Example 1 was blended with an aqueous solution of low molecular weight sodium polymethacrylate (MW 6500, 2.7 parts solid/100 parts of chloroprene monomer charged). After acidification of the dispersion with acetic acid to pH 5.5, a considerable amount of coagulum was formed, and the remaining solution could not be isolated on a freeze roll. The frozen solid did not form a self-supporting film. The coagulum recovered after coagulation had a polymer composition of 97.3 wt % polychloroprene and 2.7 wt % polymethacrylic acid based on the weight of chloroprene homopolymer plus polymethacrylic acid.

### Examples 5-8

A series of aqueous dispersions containing chloroprene homopolymer and sodium polymethacrylate were prepared substantially as described in Example 1 using the chloroprene homopolymer dispersion of Example 1 and a 29.7% aqueous solution of sodium polymethacrylate having a molecular weight of 6500 daltons. The resultant dispersions were acidified to a pH of 5.5 by addition of acetic acid. Solid polymer compositions were isolated from the acidified dispersions by contacting the dispersions with a freeze roll to form solid polymer sheets that were subsequently dried. The Mooney viscosities (ML 1+4 at 100° C.) of the isolated polymer blend compositions are as shown in Table II.

The weight percentage of polymethacrylic acid reported is based on the total weight of polychloroprene homopolymer plus polymethacrylic acid.

| | Polymethacrylic | Mooney Viscosity of |
|---|---|---|
| Example | Acid (Wt. %) | Isolated Polymer |
| 5 | 0.15 | 48.1 |
| 6 | 0.3 | 50.5 |
| 7 | 0.9 | 51.0 |
| 8 | 1.5 | 47.7 |

What is claimed is:

1. A polymer blend composition comprising a 2-chloro-1,3-butadiene homopolymer and polymethacrylic acid, wherein the polymethacrylic acid has a weight average molecular weight of not greater than about 50,000 daltons.

2. A composition of claim 1 wherein the weight average molecular weight of the polymethacrylic acid is no greater than 30,000.

3. A composition of claim 1 wherein the amount of polymethacrylic acid present in the polymer blend composition is no greater than 2.5 weight percent, based on the total weight of 2-chloro-1,3-butadiene homopolymer and polymethacrylic acid present in the polymer blend composition.

4. An adhesive composition comprising the polymer blend composition of claim 1, additionally comprising a rosin tackifier, a metal oxide, and an organic solvent.

5. A process for preparing a polychloroprene adhesive composition comprising the steps of
A. providing a polymer blend composition prepared by a process comprising the steps of
1. providing a first aqueous dispersion of a 2-chloro-1,3-butadiene homopolymer;
2. forming an aqueous mixture by blending said first aqueous dispersion with an aqueous composition comprising a polymer selected from the group consisting of polymethacrylic acids, polymethacrylic acid salts, and mixtures thereof, wherein the weight average molecular weight of said polymethacrylic acid and said polymethacrylic acid salt is not greater than about 50,000 daltons and wherein the blending step takes place under conditions such that the aqueous mixture that is formed has a pH greater than 7.0;
3. acidifying said aqueous mixture to form a second aqueous dispersion; and
4. isolating a polymer blend composition from said second aqueous dispersion, the polymer blend composition comprising said 2-chloro-1,3-butadiene homopolymer and polymethacrylic acid, wherein the polymer blend composition comprises no more than about 2.5 wt. % polymethacrylic acid, based on the total weight of 2-chloro-1,3-butadiene homopolymer and polymethacrylic acid present in the polymer blend composition; and
B. forming a polychloroprene adhesive composition comprising said polymer blend composition, a rosin tackifier and a metal oxide by mixing the polymer blend composition, tackifying resin and metal oxide with an organic solvent.

6. A process of claim 5 wherein the aqueous composition comprising a polymer selected from the group consisting of polymethacrylic acids, polymethacrylic acid salts, and mixtures thereof is an aqueous dispersion.

7. A process of claim 5 wherein the aqueous composition comprising a polymer selected from the group consisting of polymethacrylic acids, polymethacrylic acid salts, and mixtures thereof is an aqueous solution.

8. An adhesive composition produced by the process of claim 5.

9. A process for isolating a self-supporting sheet of a polymer blend composition comprising a 2-chloro-1,3-butadiene homopolymer and a polymethacrylic acid polymer, the process comprising the steps of
A. providing a first aqueous dispersion of a 2-chloro-1,3-butadiene homopolymer;
B. forming an aqueous mixture by blending said first aqueous dispersion with an aqueous composition comprising a polymer selected from the group consisting of polymethacrylic acids, polymethacrylic acid salts, and mixtures thereof, wherein the weight average molecular weight of said polymethacrylic acid and said polymethacrylic acid salt is not greater than about 50,000 and wherein the addition of said aqueous composition takes place under conditions such that the aqueous mixture that is formed has a pH greater than 7.0;
C. acidifying said aqueous mixture to form a second aqueous dispersion;
D. introducing said second aqueous dispersion to the surface of a rotating freeze roll, thereby coagulating said second aqueous dispersion to form a self-supporting film or sheet, wherein said film or sheet comprises a polymer blend composition comprising a mixture of 2-chloro-1,3-butadiene homopolymer and polymethacrylic acid, wherein the polymethacrylic acid is present in said polymer blend composition in an amount of not more than about 2.5 wt. %, based on the total weight of 2-chloro-1,3-butadiene homopolymer and polymethacrylic acid present in said polymer blend composition; and
E. removing the film or sheet from the freeze roll.

10. A process of claim 9 wherein the aqueous composition comprising a polymer selected from the group consisting of polymethacrylic acids, polymethacrylic acid salts, and mixtures thereof is an aqueous dispersion.

11. A process of claim 9 wherein the aqueous composition comprising a polymer selected from the group consisting of polymethacrylic acids, polymethacrylic acid salts, and mixtures thereof is an aqueous solution.

12. A process of claim 9 wherein the aqueous composition comprising a polymer selected from the group consisting of polymethacrylic acids, polymethacrylic acid salts, and mixtures thereof is an aqueous solution of a polymethacrylate salt having a weight average molecular weight of from 5,000 to 30,000 daltons.

13. A process of claim 9 wherein the aqueous composition comprising a polymer selected from the group consisting of polymethacrylic acids, polymethacrylic acid salts, and mixtures thereof is an aqueous solution of a polymethacrylate salt having a weight average molecular weight of from 8,000 to 12,000 daltons.
